(19) United States
(12) Patent Application Publication
(10) Pub. No.: US 2024/0289552 A1
(43) Pub. Date: Aug. 29, 2024

(54) CHARACTER-LEVEL ATTENTION NEURAL NETWORKS

(71) Applicant: Google LLC, Mountain View, CA (US)

(72) Inventors: Yi Tay, Singapore (SG); Dara Bahri, Lafayette, CA (US); Donald Arthur Metzler, Jr., Marina del Rey, CA (US); Hyung Won Chung, New York, NY (US); Jai Prakash Gupta, Fremont, CA (US); Sebastian Nikolas Ruder, London (GB); Simon Baumgartner, Brooklyn, NY (US); Vinh Quoc Tran, New York, NY (US); Zhen Qin, Mountain View, CA (US)

(21) Appl. No.: 18/564,859

(22) PCT Filed: May 27, 2022
(86) PCT No.: PCT/US2022/031469

§ 371 Date: Nov. 28, 2023

Related U.S. Application Data
(60) Provisional application No. 63/194,855, filed on May 28, 2021.

(51) Int. Cl. G06F 40/284

(52) U.S. Cl. CPC G06F 40/284

(57) ABSTRACT

Methods, systems, and apparatus, including computer programs encoded on computer storage media, for performing a machine learning task on an input sequence of characters that has a respective character at each of a plurality of character positions to generate a network output. One of the systems includes a neural network configured to perform the machine learning task, the neural network comprising a gradient-based sub-word tokenizer and an output neural network. The gradient-based sub-word tokenizer is configured to apply a learned, i.e., flexible, sub-word tokenization strategy to the input sequence of characters to generate a sequence of latent sub-word representations. The output neural network is configured to process the latent sub-word representation to generate the network output for the task.

### CROSS-REFERENCE TO RELATED APPLICATION

This application claims the benefit of priority of the filing date of U.S. Application No. 63/194,855, filed on May 28, 2021. The disclosure of the prior application is considered part of and is incorporated by reference in the disclosure of this application.

### BACKGROUND

This specification relates to using neural networks to perform machine learning tasks on text inputs.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of weights.

### SUMMARY

This specification describes a system implemented as computer programs on one or more computers in one or more locations that implements, trains, or both a neural network to perform a machine learning task on a network input that includes an input sequence of characters that has a respective character at each of a plurality of character positions to generate a network output. As used herein, a “character” refers to the general concept of a letter, number, symbol, ideograph or the like, whereas a “word” refers to a group of one or more characters. In other words, while this specification and the description below describe systems that operate on text characters, more generally, the described techniques can be used to learn and generate latent input representations of any sequence of input elements or input tokens that capture the context of the elements within the sequence.

The subject matter described in this specification can be implemented in particular embodiments so as to realize one or more of the following advantages.

Unlike many existing machine learning models configured to perform sequence processing tasks which rely on separate and fixed tokenization algorithms during pre-processing of the model inputs, e.g., text inputs, this specification describes techniques for training of a neural network system to learn a customized sub-word tokenization strategy as part of end-to-end training of the system on a given task. The neural network system thus has a smaller memory footprint relative to other existing systems because a fixed model that maps input characters to sub-words need not be stored, and thus making it practical for deployment on hardware devices, e.g., mobile system-on-chip (SOC) devices, where memory resources are limited. Once trained, the neural network system as described can outperform the state-of-the-art on a range of tasks while additionally being generalizable and easily adaptable to new tasks, e.g., relative to existing pre-trained character-level and/or sub-word-based models, because the system need not learn a new sub-word model for each new vocabulary and thereby requires less compute overhead for adaptation to a new task.

Additionally, by virtue of its flexible nature in pre-processing the sequential inputs, the neural network system as described in this specification can perform the given task with reduced runtime latency, e.g., in terms of wall clock time that is needed to perform an inference on an input. In other words, the described neural network system is fast, sometimes three times or more as fast as exiting systems, while maintaining high quality performance on the task.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system including a neural network that includes a gradient-based sub-word tokenizer.

FIG. 2 is an illustration of high-level differences between an existing neural network system that implements a traditional sub-word tokenizer and a neural network system that implements a gradient-based sub-word tokenizer.

FIG. 3 is a flow diagram of an example process for performing a machine learning task on an input sequence of characters to generate a network output.

FIGS. 4A-B are example illustrations of generating a latent sub-word representation for a character position.

Like reference numbers and designations in the various drawings indicate like elements.

### DETAILED DESCRIPTION

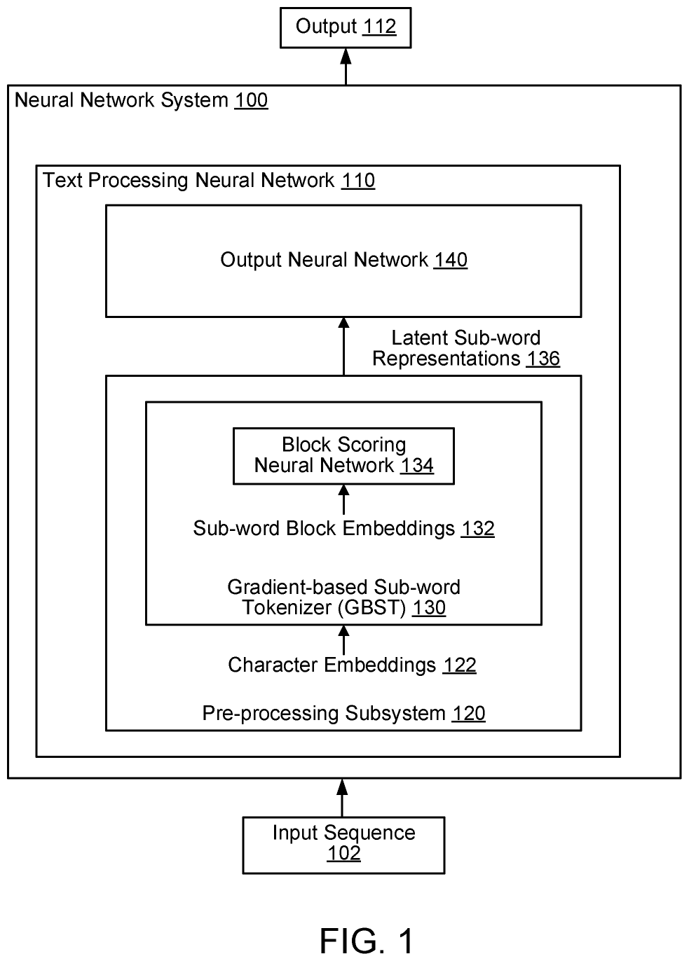

FIG. 1 shows an example neural network system 100. The neural network system 100 is an example of a system implemented as computer programs on one or more computers in one or more locations, in which the systems, components, and techniques described below can be implemented.

The neural network system 100 receives an input sequence 102 and performs a machine learning task by processing the input sequence 102 using a text processing neural network 110 to generate an output 112.

In general, the machine learning task can be any of a variety of tasks. Some examples of machine learning tasks that the system can be configured to perform follow.

As one example, the task may be a neural machine translation task. For example, if the input sequence to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input sequence is text in a natural language or features of text in a natural language and the network output is a spectrogram or other data defining audio of the text being spoken in the natural language.

As another example, the task can be a health prediction task, where the input sequence is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the input sequence is a sequence of text, and the output is another sequence of text, e.g., a completion of the input sequence of text, a response to a question posed in the input sequence, or a sequence of text that is about a topic specified by the first sequence of text.

As another example, the task can be a biological sequencing task, where input sequence is a biological sequence, e.g., a deoxyribonucleic acid (DNA), ribonucleic acid (RNA), or an amino acid sequence of a protein, and the output is an analysis result obtained from analyzing the biological sequence, or any other result generated from processing the biological sequence.

The text processing neural network 110 includes a pre-processing subsystem 120 and an output neural network 140. The pre-processing subsystem 120 pre-processes the input sequence 102 in order to generate an intermediate representation of the input sequence 102, i.e., a sequence of latent sub-word representations 136, that can be effectively processed by the output neural network 140. By employing the pre-processing techniques described in this specification, the text processing neural network 110 can more effectively and accurately perform the machine learning tasks mentioned above.

Generally, the input sequence 102 is a sequence of characters representing text. The input sequence 102 may have a respective character at each of a plurality of character positions in an input order. Each character can be a letter, number, symbol (including punctuation mark), ideograph, or the like. The input sequence 102 may not be readily adapted to be processed by the output neural network 140 for the reasons that processing input sequences in the raw text format as they are received by the system 100 would oftentimes downgrade the performance of the output neural network 140 on the tasks.

Thus, the neural network system 100 uses the pre-processing subsystem 120 to pre-process the input sequence 102 in order to generate the latent sub-word representations 136 that can be effectively processed by the output neural network 140. The pre-processing process applied by the pre-processing subsystem 120 includes the step of tokenization, and can also optionally include other text pre-processing or normalization steps including, for example, lower casing, punctuation mark or stop word removal, stemming, lemmatization, and the like.

Tokenization refers to the process of segmenting an input sequence of characters into semantically independent elements called tokens. In the neural network system 100 and unlike in existing text processing neural network systems, the tokenization is performed by using a tokenizer with learnable parameters, namely the gradient-based sub-word tokenizer (GBST) 130 included in the pre-processing subsystem 120. The gradient-based sub-word tokenizer (GBST) 130 is configured to apply a learned, i.e., flexible, sub-word tokenization strategy to the input sequence of characters. The gradient-based sub-word tokenizer (GBST) 130 includes at least one learnable neural network component (the block scoring neural network 134), and thus can also be referred to as a gradient-based sub-word tokenization neural network.

Existing techniques for tokenization, which typically include rigid sub-word-based segmentation algorithms and expert-crafted segmentation algorithms, may introduce a bottleneck into text processing neural network systems that limits their capabilities in performing the tasks mentioned above. A sub-word-based segmentation algorithm being rigid means that tokens are deterministically generated from the input sequence of characters, i.e., a same set of tokens will always be generated for a same input sequence of characters. For example, a rigid sub-word-based segmentation algorithm may split an input sequence of characters into sub-words tokens solely based on frequency, without taking into account lexical or semantic similarity. As a result, the output neural network configured to process the outputs of these existing algorithms becomes brittle to rare or infrequent words and perturbations, both natural and adversarial. When configured to perform multilingual tasks, words in low-resource languages may be split into many sub-word tokens, which impacts network performance on those languages and deteriorates cross lingual transfer. Moreover, a separate tokenization algorithm may lead to a mismatch between the pre-training and downstream distribution of words when adapting a pre-trained output neural network to new tasks, which requires significant engineering effort and associated costs to overcome.

A sub-word is usually an incomplete word, although there may also be sub-words corresponding to complete words in a vocabulary. For example, the word “certainly” may comprise the sub-words “certain” and “ly”. By complete or full words, it is meant that the words are valid words in the natural language used by the system. For example, the word “develops” can be segmented into “develop” and “s” (where develop is a valid English word). Although the example described here relates to English language, sub-word tokenization works well for many languages, and the same methods can be applied to systems based on other languages, including, for example, Chinese, Thai, and Korean.

During the processing of the input sequence 102 by the system 100 to generate the output 112, the gradient-based sub-word tokenizer (GBST) 130 receives a sequence of character embeddings 122. The sequence of character embeddings 122 can have a respective character embedding at each of the plurality of character positions in the input sequence 102. The sequence of character embeddings 122 can be embeddings derived from the input sequence 102, or embeddings generated by a preceding GBST component, e.g., a converter that is configured to convert the characters included in the input sequence 102 into embedded (i.e., numeric) representations. For example, each character embedding 122 can be a respective code point, which is a numeric value that uniquely maps to a specific character. Each character embedding 122 can be deterministically generated from the input sequence 102 in accordance with a fixed scheme or standard, e.g., the Unicode Standard. Each character embedding 122 can have a fixed size, e.g., one byte, two bytes, or three or more bytes.

For each particular character position in the sequence of character embeddings 122, the GBST 130 is configured to generate a plurality of candidate sub-word blocks and, for each candidate sub-word block, generate a respective sub-word block embedding 132. Each candidate sub-word block can include the respective character embeddings at each of one or more continuous character positions that begin from the particular character position. Each candidate sub-word block can be of different size, i.e., can include a different number of character embeddings, than each other candidate sub-word block for the particular character position. For each of the plurality of candidate sub-word blocks, the respective candidate sub-word block embedding 132 can be generated by applying a down-sampling transformation, e.g., a strided pooling function, to the one or more character embeddings included in the candidate sub-word block. Next, to generate a latent sub-word representation 136 for each particular character position in the input sequence 102, the GBST 130 can determine a weighted combination of the plurality of sub-word block embeddings 132 weighted by relevance scores, where the relevance scores for the plurality of sub-word block embeddings are determined by using a block scoring neural network 134 included in the GBST 130.

The neural network system 100 then uses the output neural network 140 to process the sequence of latent sub-word representations 136 to generate the output 112 for the machine learning task. The output neural network 140 can have any appropriate architecture that allows the neural network to map the sequence of latent sub-word representations to an output 112 for the machine learning task.

In some implementations, the output neural network 140 can be an attention-based neural network, e.g., a Transformer-based neural network, that includes one or more attention layers, in addition to other types of layers, e.g., fully-connected layers, embedding layers, and activation layers. Each attention layer is configured to receive an input sequence for the layer that includes a respective layer input at each of one or more positions, and thereafter generate an attended input sequence at least in part by applying an attention mechanism to the input sequence for the layer. The input sequence for the layer may include data derived from the input of the output neural network 140, e.g., may be generated by one or more preceding layers of the output neural network 140 from processing the latent sub-word representations 136. The attended input sequence includes a respective attended layer input at each of the one or more positions.

The specifics of different attention mechanisms that may be applied, as well as other components of attention-based neural networks, e.g., embedding layers that embed inputs to the network, the feed-forward layers within the layers of the network, and the output layers of the network that generate the network outputs, are described in more detail in Vaswani, A., et al, Attention Is All You Need, arXiv: 1706.03762, and Devlin, J., et al, BERT: Pre-training of Deep Bidirectional Transformers for Language Understanding, arXiv: 1810.04805, the entire contents of which are hereby incorporated by reference herein in their entirety.

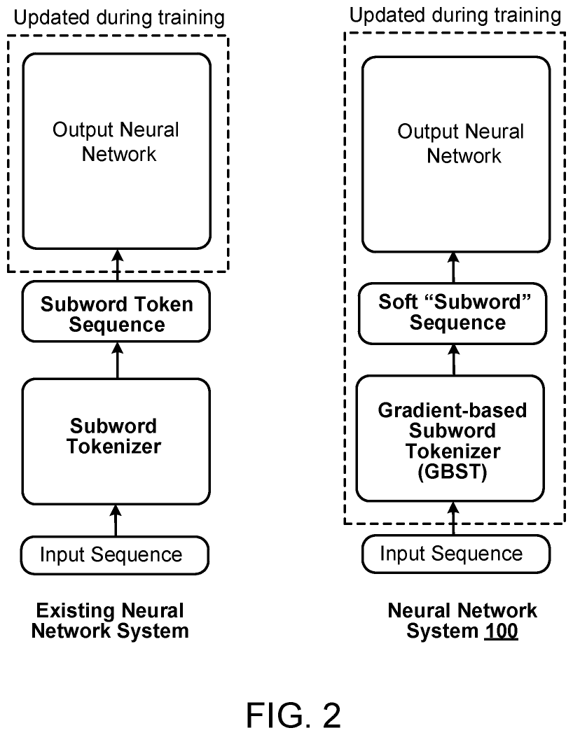

FIG. 2 is an illustration of high-level differences between an existing neural network system that implements a traditional sub-word tokenizer and a neural network system that implements a gradient-based sub-word tokenization neural network.

As illustrated on the left hand side of FIG. 2, the existing neural network system uses a traditional sub-word tokenizer to map an input sequence to a sequence of sub-word tokens, which is then processed by an output neural network to generate an output for a machine learning task. To generate the sequence of sub-word tokens, the traditional sub-word tokenizer applies a rigid segmentation algorithm. In addition to being rigid in nature, e.g., performing tokenization based solely on sub-word frequency, the traditional sub-word tokenizer is also separate from the training of the existing neural network system on the machine learning task. In other words, only the values of the network parameters of the output neural network are updated during the training.

In contrast, as illustrated on the right hand side of FIG. 2, the neural network system 100 of FIG. 1 uses a gradient-based sub-word tokenizer (GBST) that includes a block scoring neural network to map the input sequence to a sequence of soft “sub-word” tokens, i.e., the sequence of latent sub-word representations that has been generated by applying a position-wise soft selection over candidate sub-word blocks using scores computed by the block scoring neural network. Unlike the traditional sub-word tokenizer that is separate from the training of the system, the GBST can be trained end-to-end together with the output neural network on the machine learning task. In other words, during the training, not only the values of the network parameter of the output neural network are updated to optimize a loss evaluated with respect to the network outputs generated by the output neural network, but the training also jointly updates, by virtue of backpropagation and based on the loss, the values of the trainable parameters of the GBST, which include the values of the network parameter of the block scoring neural network.

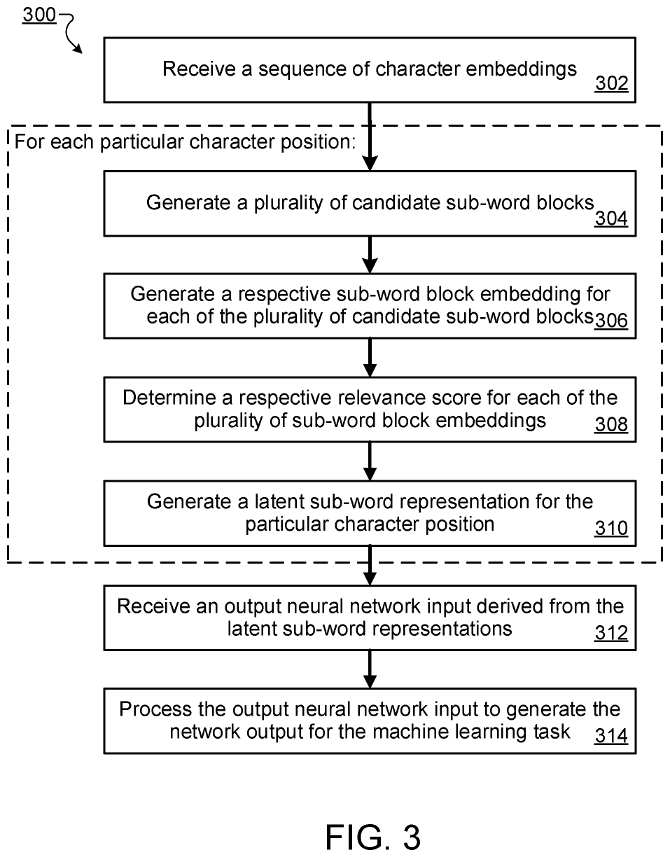

FIG. 3 is a flow diagram of an example process 300 for performing a machine learning task on an input sequence of characters to generate a network output. For convenience, the process 300 will be described as being performed by a system of one or more computers located in one or more locations. For example, a neural network system, e.g., the neural network system 100 of FIG. 1, appropriately programmed in accordance with this specification, can perform the process 300.

As described above, the neural network system can be configured to perform any of a variety of machine learning tasks on the input sequence of characters that has a respective character at each of a plurality of character positions in an input order. The neural network system includes pre-processing subsystem and an output neural network. The pre-processing subsystem includes a gradient-based sub-word tokenizer (GBST), which in turn includes a block scoring neural network.

The system receives, at the gradient-based sub-word tokenizer (GBST), a sequence of character embeddings that includes a respective character embedding at each of the plurality of character positions in the input sequence (step 302). For example, each character embedding may be a respective code point, which is a numeric value that uniquely maps to a specific character.

The system then repeatedly performs each of the followings steps 304-310 for each particular character position of the plurality of character positions generate a latent sub-word representation for the particular character position by using the gradient-based sub-word tokenizer (GBST).

The system generates a plurality of candidate sub-word blocks (step 304). Each candidate sub-word block includes the respective character embeddings at each character position in a corresponding set of one or more continuous character positions that includes the particular character position. For example, for any particular character position, each candidate sub-word block can include the character embedding at the particular character position and, optionally, the respective character embeddings at one or more continuous character positions that immediately follow or precede the particular character position.

Mathematically, if input sequence of character embeddings to the GBST is a tensor of shape X∈ [symbol] ^{L×d} where L is the number of characters and d is the character embedding dimension, and each candidate sub-word block is a contiguous span of characters X_{i:i+b} of length b for 1≤i≤L−b, then the plurality of candidate sub-word blocks can be generated by enumerating all possible blocks of size b up to a maximum block size M.

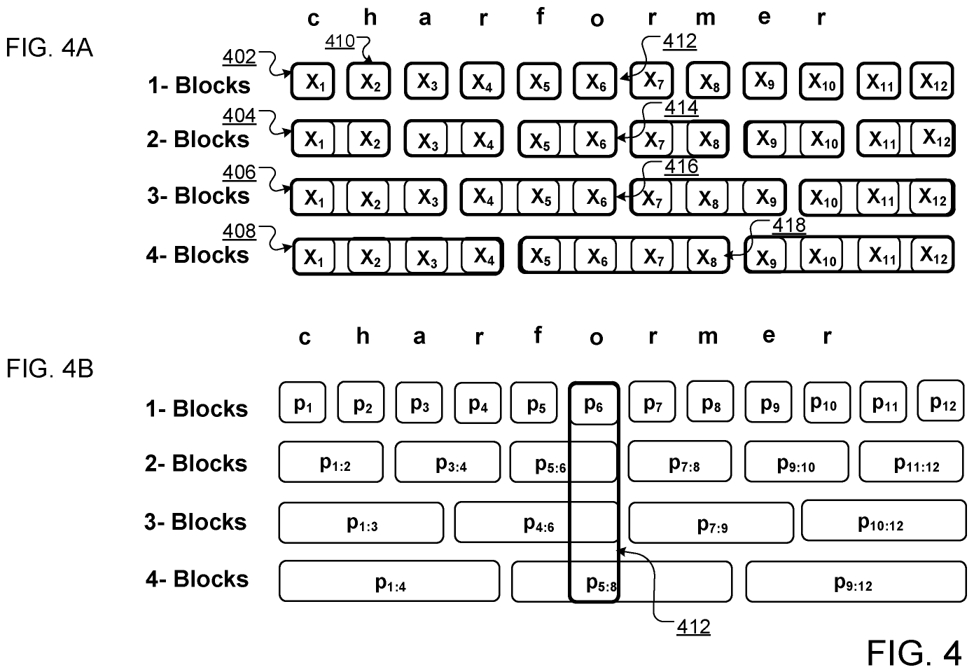

FIGS. 4A-B are example illustrations of generating a latent sub-word representation for a character position. As illustrated in FIG. 4A, for character position “C”, a first candidate sub-word block 402 includes just the character embedding x₁ at the character position; a second candidate sub-word block 404 includes the character embedding x₁ at the character position as well as the character embedding x₂ at next character position “h”; a third candidate sub-word block 406 includes the character embeddings x₁ and x₂, as well as the character embedding x₃ at a further next character position “a”; and a fourth candidate sub-word block 408 includes the character embeddings x₁, x₂, and x₃, as well as the character embedding x₄ at a further next character position “r”. In the example of FIG. 4A, the gradient-based sub-word tokenizer (GBST) generates a total of four blocks for each character position (i.e., M=4), although in some other examples, more or fewer blocks can be generated.

In addition, the GBST may generate a same candidate sub-word block for different character positions. For example, for character position “h”, while its first candidate sub-word block 410 includes just the character embedding x₂ at the character position (which is different from character position “C”), its second, third, fourth candidate sub-word blocks are identical to those generated for character position “C”, i.e., each include character embeddings x₁-x₂, x₁-x₃, and x₁-x₄, respectively.

The system generates a respective sub-word block embedding for each of the plurality of candidate sub-word blocks (step 306). The gradient-based sub-word tokenizer can apply a non-parameterized strided pooling function to each of the plurality of candidate sub-word blocks to generate the sub-word block embedding for the block. The GBST can apply the strided pooling function with a different stride configuration, i.e., with a different number of character position shifts, to each of the plurality of candidate sub-word blocks. That is, a different stride can be applied to each of the plurality of candidate sub-word blocks.

Mathematically, for a particular character position i, to project each candidate sub-word block with size b that includes a sequence of one or more character embeddings X_{i:i+b}∈ [symbol] ^{b×d} to a respective sub-word block embedding X_{b,i}∈ [symbol] ^{d} for the block at the particular character position i, the GBST can apply a non-parameterized strided pooling function F: [symbol] ^{b×d}→ [symbol] ^{d} with a stride s:

$${X}_{b} = [ F ( {X}_{i : i + b} ) ; F ( {X}_{( i + s ) : ( i + s ) + b} ) ; … ] ,$$

where X_{b} can be computed for b∈1, . . . , M, with M being a maximum block size, e.g., M=4. For example, the GBST can set stride s=b, and thus X_{b}∈ [symbol] ^{L/b×d}.

In some implementations, the GBST can shift the sequence of character embeddings by one or more character positions, e.g., up until an offset s, prior to generating the plurality of candidate sub-word blocks. The GBST can use the offset to model sliding windows of all possible candidate sub-word blocks.

In some implementations, the GBST can apply a 1-D convolution function to the sequence of character embeddings prior to generating the plurality of candidate sub-word blocks. Similar to the shifting mechanism, the 1-D convolution function effectively “smoothes” over the candidate sub-word blocks, but without increasing the computation overhead.

In some implementations, the GBST can use positional embedding to preserve the ordering of the character embeddings with each candidate sub-word block, thereby making it easier to distinguish between same sized blocks with different character orders. Specifically, for each of the plurality of candidate sub-word blocks: the GBST can determine a positional embedding for each character position included in the candidate sub-word block prior to generating the sub-word block embedding for the candidate sub-word block; and then combine an output of the non-parameterized strided pooling function with the positional embedding to generate the sub-word block embedding for the candidate sub-word block.

The system determines a respective relevance score for each of the plurality of sub-word block embeddings (step 308). The gradient-based sub-word tokenizer can process each of the plurality of sub-word block embeddings using a block scoring neural network which is configured to apply, in accordance learned values of the network parameters, a sequence of one or more transformations to a sub-word block embedding to output an initial relevance score for the sub-word block embedding. In some implementations, the block scoring neural network includes one or more fully connected layers that are each optionally followed by an activation layer.

Mathematically, given a sub-word block embedding X_{b,i}∈ [symbol] ^{d}, the initial relevance score p_{b,i} can be determined by using the block scoring neural network that is configured to apply a parameterized linear transformation F_{R}: [symbol] ^{d}→ [symbol] :

$${p}_{b , i} = {F}_{R} ( {X}_{b , i} ) .$$

The gradient-based sub-word tokenizer can then process the initial relevance scores using a softmax function to generate the final relevance score for each for each of the plurality of sub-word block embeddings. Mathematically, the final relevance score for a sub-word block embedding for a block with size b at character position i can be computed as:

$${P}_{b , i} = softmax ( [ {p}_{1 , i} , {p}_{2 , i} , … , {p}_{M , i} ] ) .$$

Optionally, the gradient-based sub-word tokenizer can additionally apply a position-wise calibration to the respective relevance scores by calculating a dot product across respective relevance scores for sub-word block embeddings at the plurality of character positions. The GBST can determine the calibrated scores \hat{P}∈ [symbol] ^{L×M} by computing \hat{P}=softmax(PP^{T})P.

The system generates a latent sub-word representation for the particular character position (step 310). For the particular character position i, the gradient-based sub-word tokenizer can generate the latent sub-word representation by determining a weighted combination of the plurality of sub-word block embeddings weighted by their final relevance scores:

$${\hat{X}}_{i} = {\sum }_{b}^{M} {P}_{b , i} {X}_{b , i} .$$

For example, as illustrated in FIG. 4B, the latent sub-word representation 412 for character position “o” can be determined as a weighted combination of the respective sub-word block embeddings for the four candidate sub-word blocks 412, 414, 416, and 418 that each include the character embedding x₆, weighted by the respective relevance scores P₆, P_{5:6}, P_{4:6}, and P_{5:8} that has been determined for the four candidate sub-word embeddings.

In some implementations, the gradient-based sub-word tokenizer is configured to apply a down-sampling function, e.g., a non-parameterized mean pooling function, to the latent sub-word representations at the plurality of character positions to generate a down-sampled latent sub-word representations for the character position. The system can then provide the down-sampled latent sub-word representations as input to the output neural network. In other implementations, the system can just provide the latent sub-word representations as input to the output neural network.

The system receives, at the output neural network, an input to the output neural network input (step 312). The input to the output neural network can either be the sequence of latent sub-word representations, or can alternatively be an input derived from the sequence of latent sub-word representations (e.g., a sequence of down-sampled latent sub-word representations).

The system processes the output neural network input using the output neural network in accordance with trained parameter values of the output neural network to generate the network output for the machine learning task (step 314). The output neural network can have any appropriate architecture that allows the neural network to map the sequence of latent sub-word representations to the output for the machine learning task.

In general, the process 300 can be performed as part of predicting a network output for a network input that includes an input sequence of characters for which the desired output, i.e., the network output that should be generated by the system for the network input, is not known.

The process 300 can also be performed as part of processing network inputs derived from a set of training data, i.e., network inputs derived from a set of inputs for which the output that should be generated by the neural network system is known, in order to train the trainable components of the text processing neural network to determine the trained values of the parameters in these components, so that the system can be deployed for use in effectively performing a machine learning task. Specifically, the trainable components of the text processing neural network includes the output neural network, as well as the block scoring neural network included in the gradient-based sub-word tokenizer.

The system can repeatedly perform the process 300 on network inputs selected from a set of training data as part of a conventional machine learning training technique to train the text processing neural network, e.g., a gradient descent with backpropagation training technique that uses a conventional optimizer, e.g., stochastic gradient descent, Adafactor, or Adam optimizer, to optimize a loss computed by evaluating an objective function that is specific to the machine learning task. During training, the system can incorporate any number of techniques to improve the speed, the effectiveness, or both of the training process. For example, the system can first pre-train the gradient-based sub-word tokenizer, the output neural network, or both on unlabeled training data and by optimizing a self-supervised or unsupervised learning objective function, and then fine-tune the networks on a specific downstream task on labeled training data and by optimizing a supervised learning objective function. For example, the system can use the pre-training technique described in Raffel, C. et al, Exploring the limits of transfer learning with a unified text-to-text transformer, arXiv preprint arXiv: 1910.10683 (2019), to train the gradient-based sub-word tokenizer together with another neural network (which need not be the same as the output neural network) to predict missing or otherwise corrupted tokens in the training network inputs.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for performing a machine learning task on an input sequence of characters that has a respective character at each of a plurality of character positions to generate a network output, the system comprising one or more computers and one or more storage devices storing instructions that, when executed by the one or more computers, cause the one or more computers to perform one or more operations to implement:
a neural network configured to perform the machine learning task, the neural network comprising a gradient-based sub-word tokenizer and an output neural network, the gradient-based sub-word tokenizer configured to:
receive a sequence of character embeddings that includes a respective character embedding at each of the plurality of character positions; and
for each particular character position of the plurality of character positions:
generate a plurality of candidate sub-word blocks, each candidate sub-word block comprising the respective character embeddings at each character position in a corresponding set of one or more continuous character positions that includes the particular character position;
generate a respective sub-word block embedding for each of the plurality of candidate sub-word blocks;
determine a respective relevance score for each of the plurality of sub-word block embeddings, comprising processing each of the plurality of sub-word block embeddings using a block scoring neural network; and
generate a latent sub-word representation for the particular character position, comprising determining a weighted combination of the plurality of sub-word block embeddings weighted by the relevance scores, and
the output neural network configured to:
receive an output neural network input derived from the latent sub-word representations at the plurality of character positions; and
process the output neural network input to generate the network output for the machine learning task.

2. The system of claim 1, wherein the gradient-based sub-word tokenizer is further configured to apply a down-sampling function to the latent sub-word representations at the plurality of character positions to generate the output neural network input.

3. The system of claim 2, wherein the down-sampling function comprises a non-parameterized mean pooling function.

4. The system of claim 1, wherein the output neural network comprises one or more attention neural network layers that are each configured to:
apply an attention mechanism to an attention layer input derived from the output neural network input to generate an attention layer output for the attention neural network layer.

5. The system of claim 1, wherein, for each particular character position of the plurality of character positions: each candidate sub-word block comprises the respective character embeddings at each of the one or more continuous character positions that begin from the particular character position.

6. The system of claim 1, wherein the gradient-based sub-word tokenizer is configured to generate the respective sub-word block embedding for each of the plurality of candidate sub-word blocks based on applying a non-parameterized strided pooling function to each of the plurality of candidate sub-word blocks, wherein the strided pooling function is applied with a different stride configuration to each of the plurality of candidate sub-word blocks.

7. The system of claim 1, wherein the gradient-based sub-word tokenizer is further configured to shift the sequence of character embeddings by one or more character positions prior to generating the plurality of candidate sub-word blocks.

8. The system of claim 1, wherein the gradient-based sub-word tokenizer is further configured to apply a 1-D convolution function to the sequence of character embeddings prior to generating the plurality of candidate sub-word blocks.

9. The system of claim 6, wherein the gradient-based sub-word tokenizer is further configured to, for each of the plurality of candidate sub-word blocks:
determine a positional embedding for each character position included in the candidate sub-word block prior to generating the sub-word block embedding for the candidate sub-word block; and
combine an output of the non-parameterized strided pooling function with the positional embedding to generate the sub-word block embedding for the candidate sub-word block.

10. The system of claim 1, wherein the gradient-based sub-word tokenizer is configured to determine the respective relevance score for each of the plurality of sub-word block embeddings based on applying a parameterized linear transformation function to each of the plurality of sub-word block embeddings.

11. The system of claim 1, wherein the gradient-based sub-word tokenizer is further configured to apply a position-wise calibration to the respective relevance scores by calculating a dot product across respective relevance scores for sub-word block embeddings at the plurality of character positions.

12. One or more non-transitory computer-readable storage media storing instructions that when executed by one or more computers cause the one or more computers to implement:
a neural network configured to perform a machine learning task on an input sequence of characters that has a respective character at each of a plurality of character positions to generate a network output, the neural network comprising a gradient-based sub-word tokenizer and an output neural network, the gradient-based sub-word tokenizer configured to:
receive a sequence of character embeddings that includes a respective character embedding at each of the plurality of character positions; and
for each particular character position of the plurality of character positions:
generate a plurality of candidate sub-word blocks, each candidate sub-word block comprising the respective character embeddings at each character position in a corresponding set of one or more continuous character positions that includes the particular character position;
generate a respective sub-word block embedding for each of the plurality of candidate sub-word blocks;
determine a respective relevance score for each of the plurality of sub-word block embeddings, comprising processing each of the plurality of sub-word block embeddings using a block scoring neural network; and
generate a latent sub-word representation for the particular character position, comprising determining a weighted combination of the plurality of sub-word block embeddings weighted by the relevance scores, and
the output neural network configured to:
receive an output neural network input derived from the latent sub-word representations at the plurality of character positions; and
process the output neural network input to generate the network output for the machine learning task.

13. A method performed by one or more computers, the method comprising:
receiving an input sequence of characters that has a respective character at each of a plurality of character positions; and
processing the input sequence using a neural network to generate a network output for a machine learning task, the neural network comprising a gradient-based sub-word tokenizer and an output neural network, the gradient-based sub-word tokenizer configured to:
receive a sequence of character embeddings that includes a respective character embedding at each of the plurality of character positions; and
for each particular character position of the plurality of character positions:
generate a plurality of candidate sub-word blocks, each candidate sub-word block comprising the respective character embeddings at each character position in a corresponding set of one or more continuous character positions that includes the particular character position;
generate a respective sub-word block embedding for each of the plurality of candidate sub-word blocks;
determine a respective relevance score for each of the plurality of sub-word block embeddings, comprising processing each of the plurality of sub-word block embeddings using a block scoring neural network; and
generate a latent sub-word representation for the particular character position, comprising determining a weighted combination of the plurality of sub-word block embeddings weighted by the relevance scores, and
the output neural network configured to:
receive an output neural network input derived from the latent sub-word representations at the plurality of character positions; and
process the output neural network input to generate the network output for the machine learning task.

14. The method of claim 13, further comprising training the neural network by jointly training the gradient-based sub-word tokenizer and the output neural network based on optimizing a supervised learning objective function.

15. The method of claim 14, wherein the gradient-based sub-word tokenizer has been pre-trained jointly with a different output neural network based on optimizing a different objective function.

16. The method of claim 15, wherein the different objective function comprises a self-supervised learning objective function.

17. The method of claim 13, wherein the gradient-based sub-word tokenizer is further configured to apply a down-sampling function to the latent sub-word representations at the plurality of character positions to generate the output neural network input.

18. The system of claim 17, wherein the down-sampling function comprises a non-parameterized mean pooling function.

19. The method of claim 13, wherein the output neural network comprises one or more attention neural network layers that are each configured to:
apply an attention mechanism to an attention layer input derived from the output neural network input to generate an attention layer output for the attention neural network layer.

20. The method of claim 13, wherein, for each particular character position of the plurality of character positions: each candidate sub-word block comprises the respective character embeddings at each of the one or more continuous character positions that begin from the particular character position.
